(19) United States
(12) Patent Application Publication
(10) Pub. No.: US 2025/0128939 A1
(43) Pub. Date: Apr. 24, 2025

(54) Delivery of high temperature hydrogen via hydrocarbon pyrolysis

(71) Applicant: Molten Industries Inc., Oakland, CA (US)

(72) Inventors: Kevin A. Bush, Oakland, CA (US); Caleb C. Boyd, San Francisco, CA (US); Brandon J. Stitt, Alameda, CA (US)

(21) Appl. No.: 18/919,931

(22) Filed: Oct. 18, 2024

Related U.S. Application Data
(60) Provisional application No. 63/544,929, filed on Oct. 19, 2023.

(51) Int. Cl. C01B 3/24; B01J 6/00; C01B 32/05

(52) U.S. Cl. CPC C01B 3/24; B01J 6/008; C01B 32/05; C01B 2203/0272; C01B 2203/0277; C01B 2203/0405; C01B 2203/043; C01B 2203/049; C01B 2203/0883; C01B 2203/1241

(57) ABSTRACT

A chemical process and system using a pyrolysis reactor that pyrolyzes a hydrocarbon feedstock, e.g., methane or natural gas, to produce a processed hydrogen gas at a high gas temperature. The pyrolysis reactor issues a high temperature fluid flow of pyrolysis products including hydrogen and a solid carbon product that are sent to a heat exchanger to cool them to a low temperature fluid flow of pyrolysis products. A processing system connected to the heat exchanger receives the low temperature fluid flow and generates the processed hydrogen gas at a low gas temperature and then delivers a gas flow of the processed hydrogen gas at the low gas temperature back to the heat exchanger to serve as working fluid that cools down the high temperature fluid flow of pyrolysis gases. Advantageously, this exchange heats the gas flow at the low gas temperature and thus yields the processed hydrogen gas at the high gas temperature.

### CROSS-REFERENCE TO RELATED APPLICATIONS

This application claims priority from U.S. Provisional Patent Application No. 63/544,929 filed on Oct. 19, 2023 and which is incorporated herein by reference for all purposes in its entirety.

### FIELD OF THE INVENTION

The present invention relates to the production and delivery of hydrogen via thermochemical decomposition or pyrolysis of hydrocarbon feedstock such as methane, and more specifically to the processing of hot pyrolysis gases that include hydrogen and carbon with the aid of a heat exchanger for cooling prior to carbon removal and then reusing the cooled hydrogen as working fluid in the heat exchanger prior to delivering it as high temperature hydrogen at over 250° C.

### BACKGROUND OF THE INVENTION

The United States produces 10 million metric tons of hydrogen per year. 95% of it is produced via steam methane reforming (SMR) and is accompanied by the emission of 100 million tons of CO₂ in the process, as documented by A. Majumdar et al., “A framework for a hydrogen economy”, Joule, Vol. 4, Issue 8, 18 Aug. 2021, pp. 1905-1908.

Methane pyrolysis, also known as methane cracking or methane splitting, involves the thermochemical decomposition of a hydrocarbon feedstock primarily composed of methane (CH₄) into its constituent elements, namely hydrogen (H₂) and solid carbon. Note that other products of the hydrocarbon decomposition process may be formed such as ethane, ethylene, acetylene and benzene. The pyrolysis process is typically conducted at elevated temperatures, often above 1,000° C., in the absence of oxygen to avoid the formation of gaseous carbon dioxide (CO₂) and carbon monoxide (CO). Furthermore, the pyrolysis process is endothermic and requires a substantial input of heat energy to break the carbon-hydrogen bonds in methane.

Methane pyrolysis is potentially the most cost-effective solution to reduce emissions associated with hydrogen production. Unfortunately, the existing approaches have proved difficult to scale. Scaling issues have been documented by M. Steinberg, “The direct use of natural gas for conversion of carbonaceous raw materials to fuels and chemical feedstocks”, International Journal of Hydrogen Energy, Vol. 11, Issue 11, 1986, pp. 715-720 and also by S. Schneider et al., “State of the Art of Hydrogen Production via Pyrolysis of Natural Gas, ChemBioEng Reviews, Vol. 7, 2020, pp. 1-10. Still, obtaining hydrogen via methane decomposition holds the promise of being less expensive than producing it through water electrolysis or through existing steam methane reforming with carbon capture.

Thermal decomposition of a hydrocarbon feedstock such as methane can be performed with or without the presence of an active catalyst. In the absence of a catalyst, temperatures for thermal decomposition of methane into hydrogen and solid carbon are typically above 1,000° C. Catalytic materials can reduce the temperature of thermal decomposition to as low as 400° C. or even lower. Catalytic materials for the decomposition of hydrocarbons include but are not limited to Group VIb and VIII elements of the periodic table such as iron (Fe), nickel (Ni), cobalt (Co), noble metals, chromium (Cr), molybdenum (Mb), alloys of these metals and even salts and oxides containing these metals.

With or without catalysts, scalable, cost-effective methane pyrolysis has yet to be widely commercialized as it presents a number of fundamental process design and scale-up challenges. The high temperature requirements constrain the choice of construction materials and require efficient heat transfer at high throughputs. The process generates both gaseous hydrogen and solid carbon, which must be physically separated. In fact, deposition of solid carbon in the reactor or coking is a major operational problem for thermal decomposition of any hydrocarbon feedstock. Further, the process requires frequent reactor cleaning. This results in downtime and non-continuous operation. Catalysts are deactivated by solid carbon deposition and must be replaced or cleaned. Catalytic metals and salts can contaminate the solid carbon byproduct such that it cannot be used in all applications. Indeed, in some cases the extent of contamination is so high that the solid carbon byproduct must even be disposed of as toxic waste.

Patents on the thermal decomposition of a hydrocarbon feedstock have been around for over a century. One of the first is U.S. Pat. No. 1,107,926 by Albert Rudolph Frank who observed the decomposition of methane at temperatures over 1, 200° C. Auguste Jean Paris Jr. was the first to patent methane pyrolysis in molten media in 1915 in U.S. Pat. Nos. 1,756,877 and 1,392,788. Typical approaches to hydrocarbon decomposition include moving bed and fluidized bed reactors, plasma reactors, microwave reactors, molten bath reactors and fluid wall reactors. The primary challenge in the operation of a continuous or semi-continuous methane pyrolysis process lies in overcoming reactor fouling caused by the formation of solid carbon. Solid carbon can coat reactor surfaces. This is especially true in cases where the thermal decomposition occurs at a surface and leads to the formation of a hard carbon deposit thereon. The deposit can build up to the point where it could clog the reactor and thus force a shutdown and cleaning.

Plasma, microwave and fluidized bed reactors typically attempt to overcome the carbon fouling issue by ensuring that energy or heat is transferred to the methane away from the walls of the reactor, thus forming a carbon product that can be fluidized out of the reactor. The challenge with these reactors is that their walls typically need to be cooled to avoid carbon deposition on them, thus lowering the energy efficiency of the reactor.

Energy efficiency is an important consideration in the design of a methane pyrolysis reactor, especially when a primary goal is the production of clean hydrogen. Clean hydrogen is defined as hydrogen that was produced with minimal carbon dioxide (CO₂) emissions. In order to minimize CO₂ emissions, it is preferable to utilize renewable energy sources such as geothermal, wind, solar thermal, solar photovoltaics, But methane pyrolysis must compete against other or nuclear energy, methods for producing clean hydrogen such as water electrolysis which also uses electricity, ideally from renewable sources. Methane pyrolysis has the potential to use approximately seven times less energy than water electrolysis, but the high temperatures involved in the pyrolysis reaction have made it challenging to develop a highly energy efficient process which is close to the theoretical minimum energy input of ˜5.2 kWh/kg-H2. Energy losses can come from the reactor itself, from the method of heating, or from poor heat recovery from the product gasses from the pyrolysis reaction.

When considering the energy efficiency of the reactor alone, it would be beneficial to recover all of the heat in the product gasses of pyrolysis by recycling all of that heat into the feedstock gas stream. Since the thermal mass of the feedstock gasses should be roughly equivalent to the thermal mass of the product gasses and solid carbon, it would be ideal if a heat exchanger could transfer all the heat from the products to the feedstock, thus enabling the pyrolysis reactor to operate close to its theoretical minimum energy input. The challenge is that the hydrocarbon feedstock undergoes thermal decomposition at temperatures greater than 900° C., and much more rapidly at temperatures greater than 1,100° C. To make matters even more challenging, typical high temperature tubing and piping materials for routing the feedstock gas are usually made of materials which are catalytic to hydrocarbon decomposition such as iron and nickel, thus further lowering the decomposition temperature to near 700° C. This makes it so that the hydrocarbon feedstock cannot be easily pre-heated above 700° C. if it is to be routed through iron- or nickel-based piping, thus significantly reducing the amount of thermal energy that can be recovered from the product gasses. There is prior art that teaches energy recovery by preheating the methane feedstock gas with the product gasses. This art includes US Published Application 2021/0032102 A2 which specifies that the maximum preheat temperature is 700° C.

In contrast to recovering the thermal energy in the high temperature pyrolysis gasses and solid carbon produced from the pyrolysis reaction by preheating the feedstock gas, the thermal energy can be used in subsequent processes downstream of the reactor. U.S. Pat. No. 9,834,440 by BASF and US Provisional Application 63/466,464 by Molten Industries describe processes to leverage the high temperature of the hydrogen gas to react with carbon dioxide in the reverse water gas shift reaction to form carbon monoxide and water, which is thermodynamically favorable at high temperatures. However, this prior art teaches removal of the solid carbon while maintaining the hydrogen at high temperatures. This requires high temperature cyclones or ceramic filters and limits the ability to perform other purification or compression processes on the hydrogen gas. High temperature solid carbon removal technologies also have limited particulate removal effectiveness, especially for particulate size <10 um.

The importance of purifying the hydrogen product while maintaining the hydrogen at high temperatures is also addressed by Bhaskar et al. “Can methane pyrolysis based hydrogen production lead to the decarbonisation of iron and steel industry?”, Energy Conversion and Management: X, Mar. 10, 2021, pgs. 1-15. Bhaskar et al. describe the usage of a pressure swing absorption (PSA) unit to separate out hydrocarbons from the pyrolysis gasses to produce a purified hydrogen product. However, this concept faces challenges in commercial implementation as it assumes the usage of a PSA unit that operates at 900° C. A PSA requires the usage of valves, high pressure pumps, and high pressure storage tanks to adsorb and desorb gasses at pressures up to 40 bar-all of which will be difficult to operate at high temperatures. Most steels and stainless steels should not be operated above 760° C. Most pumps have polymeric gaskets which would not work at temperatures above 300° C. Metal gaskets could be employed for higher temperature operation, but this would increase cost and complexity. There are examples of high temperature PSA units for hydrogen purification at temperatures up to 450° C. to achieve a 95% hydrogen recovery ratio. If a PSA was operated at 450° C., the hydrogen would need to be heated prior to entering a downstream application such as an iron ore reduction furnace. Additionally, it is not desirable to lose 5% of the hydrogen created in the PSA for economic reasons and environmental reasons as hydrogen is an indirect greenhouse gas. There is also the possibility that unreacted methane from the pyrolysis reactor would decompose into solid carbon and hydrogen in a high temperature PSA. This could lead to considerable challenges such as coking of the adsorbent material, clogging of the PSA, deactivation of the adsorbent in the PSA, and therefore a reduction in the separation efficiency and hydrogen recovery in the PSA unless the adsorbent is cleaned or replaced, a costly and inefficient operation requiring plant downtime.

To further motivate the usage of high temperature hydrogen, the reduction of iron oxide to metallic iron is typically performed in a furnace, such as a shaft furnace, rotary kiln, or fluidized bed, at temperatures between 650° C. and 1,200° C. A shaft furnace is the most commonly used in industry for reduction of iron ore by a mixture of carbon monoxide (CO) and hydrogen (H₂). The kinetics of reduction by hydrogen should be faster and thus may help to enable the usage of a fluidized bed. Fluidized bed reduction furnaces can use iron ore fines, which saves on the energy intensity of creating iron ore pellets which are used in shaft furnaces. The shaft furnace is designed to simulate a plug flow reactor where reactions occur uniformly in the radial direction and changes composition along the axial direction as gas travels up through the packed bed of DRI pellets. Because a fluidized bed requires that the gasses can partially lift the weight of the iron ore, the reducing gas in a shaft furnace needs to be delivered at a positive pressure of 1-10 bar above atmospheric pressure.

The requirement for elevated pressure hydrogen delivery is present for nearly every industrial application of hydrogen. When the hydrogen is combusted to produce heat in a cement kiln, boiler, or turbine, the hydrogen typically needs to be delivered at 1-10 bar above atmospheric pressure. When hydrogen is used for chemical production either as a feedstock for methanol, olefins, ammonia, or plastics or as a reducing agent for petrochemical refining, the hydrogen must be delivered between approximately 30-300 bar. And when hydrogen is used as an energy carrier, fuel, or for energy storage, the pressure required can reach 900 bar. It is very difficult to compress hydrogen in any industrial compressor when the hydrogen is at elevated temperatures.

Thus, the present invention is aimed at overcoming the limitations of the prior art and delivering hydrogen at high temperatures in a suitable form for industrial applications that have additional requirements such as high purity or high pressure.

### Objects and Advantages

The present invention is aimed at overcoming the challenges in delivery of high temperature, high pressure and high purity hydrogen obtained through pyrolysis of a hydrocarbon feedstock such as methane while simultaneously overcoming the challenges associated with handling high temperature hydrogen.

It is another object of the invention to leverage the heat exchange process in conjunction with pyrolysis of hydrocarbon feedstock to deliver high temperature processed hydrogen gas while also simplifying the separation of solid carbon product from the pyrolysis gases.

### SUMMARY OF THE INVENTION

The objects and advantages of the invention are provided for by a chemical process and a chemical system for producing a processed hydrogen gas at a high gas temperature. The chemical system has a pyrolysis reactor for pyrolyzing a hydrocarbon feedstock such as methane or natural gas (a process also known as cracking or direct decomposition) to produce a high temperature fluid flow of pyrolysis products containing primarily hydrogen and a solid carbon product which, depending on the operating conditions of the pyrolysis reactor, may in fact be primarily solid carbon.

The chemical system has a heat exchanger that is connected to the pyrolysis reactor such that it receives the high temperature fluid flow of the pyrolysis products exiting the pyrolysis reactor and delivers a low temperature fluid flow of these pyrolysis products. In other words, the heat exchanger is configured to cool down the high temperature fluid flow. The chemical system is further equipped with a processing system connected to the heat exchanger. The processing system receives the low temperature fluid flow of pyrolysis products and processes the pyrolysis products to obtain the processed hydrogen gas at a low gas temperature.

The processing system then delivers a gas flow of the processed hydrogen gas at the low gas temperature back to the heat exchanger in the role of working fluid that cools down the high temperature fluid flow of pyrolysis gases. In other words, the heat exchanger exchanges heat between the high temperature fluid flow of the pyrolysis products and the gas flow of the processed hydrogen gas that is delivered from the processing system at the low gas temperature. Advantageously, this exchange of heat also heats the gas flow that entered at the low gas temperature and thus the processed hydrogen gas reaches a high gas temperature during this exchange while also serving the function of working fluid.

In order to obtain the desired solid carbon product, e.g., solid carbon, the chemical system operates the pyrolysis reactor at a sufficiently high temperature. For example, the pyrolysis reactor pyrolyzes the hydrocarbon feedstock at temperatures ranging between 500° C. and a 2,000° C. Operating at high temperatures and also producing sufficiently rapid high temperature fluid flow of pyrolysis products is further advantageous because it fluidizes a fraction of the solid carbon product out of the pyrolysis reactor. Of course, such operation is responsible for the high temperature fluid flow of pyrolysis products, which is difficult to process at the high temperatures at which it exits the pyrolysis reactor. According to the invention, however, the disadvantage of high temperature operation is turned into an advantage by the use of the heat exchanger that simultaneously cools down the pyrolysis products to render them easy to process and also obtains hydrogen gas at a high gas temperature by deploying gas flow of the processed hydrogen gas at the low gas temperature as the working fluid. In other words, the chemical system of the invention processes the hydrogen at low temperature and then reheats it while also taking advantage of the very same processed hydrogen gas to cool down the pyrolysis products.

The chemical system can use various types of hydrocarbon feedstock including gasses, liquids, or solids containing one or more hydrocarbons such as methane, butane, propane, ethane, ethylene, acetylene, propylene, natural gas, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons. Mixtures of any of the above feedstocks with other hydrocarbon feedstocks can be used, as well as mixtures containing any of these feedstocks with other feedstocks such as mixtures of methane and nitrogen, methane and carbon dioxide, or methane and carbon monoxide. A preferred embodiment uses natural gas or a hydrocarbon feedstock primarily composed of methane. When using methane, it is preferable that the pyrolysis reactor be set to maintain a hydrogen reaction yield of more than 70%.

In some embodiments the processing system has a separator for separating out the solid carbon product. Preferably, over 60% of the solid carbon product is removed or separated by the separator from the low temperature fluid flow of pyrolysis gas to yield processed hydrogen gas that contains over 70% hydrogen. There are various types of separators that can be deployed in the processing system. In some cases, the separator is a solid filter such as a cyclone, a baghouse filter or a HEPA filter. In other cases, the separator is a gas filter such as a pressure or temperature swing absorption system, a distillation system or a membrane separator.

The processing system can be equipped with many devices that take advantage of the low temperature fluid flow that is much easier to handle than the high temperature fluid flow to perform additional useful functions. For example, the processing system has a compressor for increasing the pressure of the low temperature fluid flow to between 1 and 1,000 bar absolute pressure. The processing system can have a measurement device for measuring a flow rate of the gas flow of the processed hydrogen at the low gas temperature. Further, the processing system can have a gas analyzer for measuring a chemical composition and a purity of the processed hydrogen while at the low gas temperature.

The heat exchanger is preferably configured to decrease the temperature of the high temperature fluid flow of the pyrolysis products to below 500° C. and even more preferably below 300° C. Furthermore, the heat exchanger can also be used to exchange heat between the high temperature fluid flow of the pyrolysis products and the hydrocarbon feedstock to be used in the pyrolysis reactor. This is advantageous since it helps to pre-heat the hydrocarbon feedstock before it is delivered to the pyrolysis reactor and thus improve the overall energy efficiency of the chemical system.

Depending on the use of the processed hydrogen gas its final parameters may be adjusted. In many cases it is desirable for the processed gas to be delivered from the chemical system at higher temperatures. Thus, the heat exchanger can be configured to increase the temperature of the gas flow of the processed hydrogen gas serving as the working fluid such that the high gas temperature is above 300° C. or even above 700° C.

There are many types of heat exchangers that can be deployed in the chemical system of the invention. In a preferred embodiment the heat exchanger is a counter-flow heat exchanger. Additionally, the heat exchanger can use other typical working fluids during operation. For example, the heat exchanger can exchange heat between the high temperature fluid flow of the pyrolysis products and at least one heat exchange fluid selected from among more typical working fluids or working fluid components such as air, steam, molten metals, molten salts and water.

The chemical process of the invention and the chemical system are described in detail in the below detailed description with reference to the attached drawing figures.

### BRIEF DESCRIPTION OF THE DRAWING FIGURES

FIG. 1A is a schematic diagram of a chemical system for obtaining a processed hydrogen gas at a high gas temperature in accordance with the invention

FIG. 1B is a partial sectional view of the heat exchanger belonging to the chemical system of FIG. 1A

FIG. 2 is a flow diagram that explains the operation of the chemical system of FIG. 1A

FIG. 3A is a thermal plot illustrating the heat exchange step occurring in the heat exchanger between hot fluid flow and working fluid flow over a length of 3 m

FIG. 3B is a thermal plot illustrating the heat exchange step occurring in the heat exchanger between hot fluid flow and working fluid flow over a length of 4 m

FIG. 4A shows an alternative counter-flow heat exchanger

FIG. 4B is a cross-section illustrating the interior of the alternative counter-flow heat exchanger of FIG. 4B

FIG. 5A illustrates a cyclone for deployment in the processing system of the chemical system of FIG. 1A

FIG. 5B illustrates a candle filter for deployment in the processing system of the chemical system of FIG. 1A

FIG. 6 is a schematic diagram of a chemical system for obtaining a processed hydrogen gas at a high gas temperature and for heating hydrocarbon feedstock

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in n the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

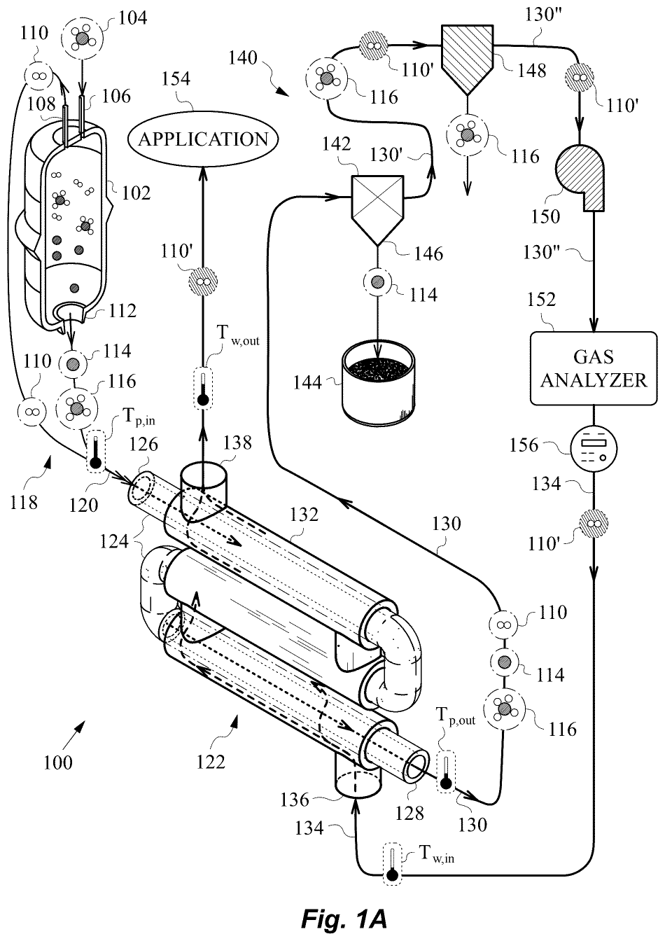

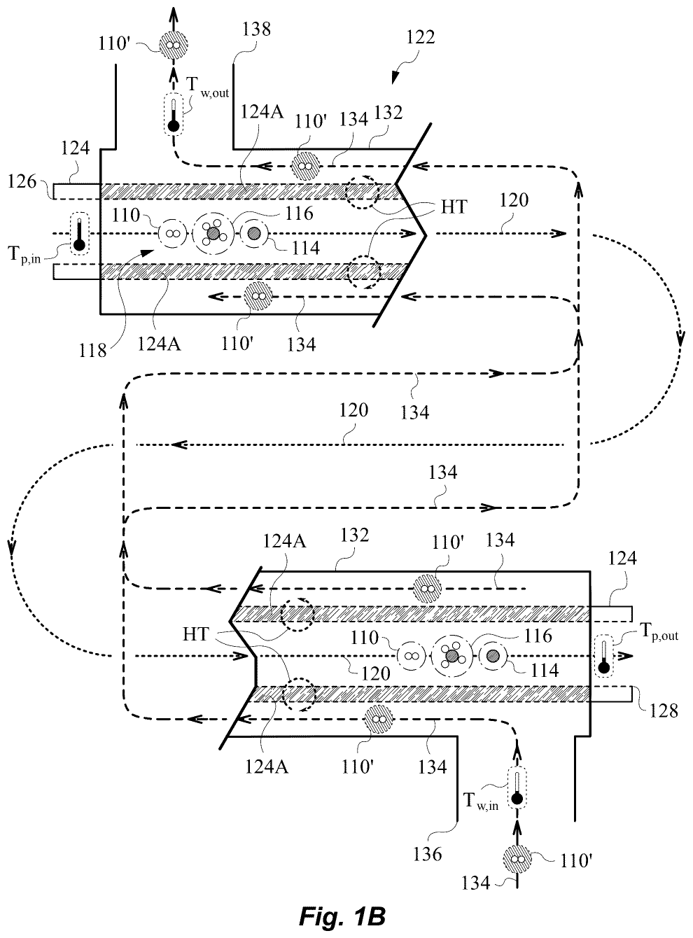

FIG. 1A is a schematic diagram of a chemical system 100 according to the invention. Chemical system 100 is shown in a partial three-dimensional view for purposes of clear explanation and visualization.

Chemical system 100 has a pyrolysis reactor 102 for pyrolyzing a hydrocarbon feedstock 104 such as primarily or essentially methane or natural gas. Pyrolyzation or thermochemical decomposition is also known as cracking or direct decomposition by those skilled in the art.

In the present embodiment, hydrocarbon feedstock is methane 104 (CH₄). Methane 104 is visualized in highly magnified molecular form within a dashed and dotted outline.

It is noted that chemical system 100 can use various types of hydrocarbon feedstock 104 including gasses, liquids, or solids containing one or more hydrocarbons such as methane, butane, propane, ethane, ethylene, acetylene, propylene, natural gas, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons. Mixtures of any of the above feedstocks with other hydrocarbon feedstocks can be used, as well as mixtures containing any of these feedstocks with other feedstocks such as mixtures of methane and nitrogen, methane and carbon dioxide, or methane and carbon monoxide. A preferred embodiment uses natural gas or a hydrocarbon feedstock primarily composed of methane (CH₄) as in the present embodiment.

Further, it should be noted that pyrolysis reactor 102 can include purifying systems, separation systems, or gasification systems before its thermal decomposition stage to purify hydrocarbon feedstock 104 for decomposition and after the thermal decomposition reactor 102 to separate out and purify products of thermal decomposition. A typical example for a pre-treatment is desulfurization of natural gas.

Many specific types of pyrolysis reactors can be used in chemical system 100. For example, pyrolysis reactor 102 can be a thermal pyrolysis reactor, a microwave pyrolysis reactor, a plasma pyrolysis reactor, a liquid metal containing pyrolysis reactor, a liquid salt containing pyrolysis reactor and a catalytic pyrolysis reactor. Preferably, pyrolysis reactor 102 is a thermal, plasma or microwave driven reactor where hydrocarbon feedstock 104 is thermally decomposed.

Pyrolysis reactor 102 has an inlet 106 for admitting hydrocarbon feedstock 104. Further, pyrolysis reactor 102 has a top outlet 108 for releasing hydrogen 110 which is one of the pyrolysis products. At the bottom, pyrolysis reactor 102 has a bottom outlet 112 for releasing a pyrolysis carbon product 114. Pyrolysis carbon product 114 in the present embodiment is solid carbon visualized in highly magnified molecular form within a dashed and dotted outline. In fact, pyrolysis reactor 102 should be set up to decompose hydrocarbon feedstock 106 into primarily solid carbon product 114 and hydrogen 110. Nevertheless, pyrolysis reactor 102 typically also releases a hydrocarbon fraction 116. Hydrocarbon fraction 116 at bottom outlet 112 is principally composed of unreacted hydrocarbon feedstock 104, in this case methane (CH₄). Hence, it is also visualized in FIG. 1A in highly magnified molecular form within dashed and dotted outline. More generally, however, hydrocarbon fraction 116 consists of a variety of hydrocarbons such as methane, ethane, ethylene, and acetylene, aromatic hydrocarbons.

Together, pyrolysis-derived hydrogen 110, pyrolysis carbon product or solid carbon product 114 and hydrocarbon fraction 116 constitute pyrolysis products 118. In the present invention the most important components of pyrolysis products 118 are hydrogen 110 and solid carbon product 114. Thus, when pyrolysis products 118 are referred to herein it will be understood that they contain at least these most important components. Furthermore, pyrolysis reactor 102 preferably operates so as to fluidize out solid carbon product 114 with pyrolysis products 118.

Pyrolysis reactor 102 is connected to power supply (not shown) for heating pyrolysis reactor 102 to a high pyrolyzation temperature to pyrolyze hydrocarbon feedstock 104. Specifically, pyrolysis reactor 102 is supplied with sufficient power to drive pyrolyzation of hydrocarbon feedstock 104 in an oxygen-free environment where hydrocarbons thermochemically decompose, preferably without catalyst at temperatures ranging between 500° C. and 2,000° C. As a result, pyrolysis products 118 exiting pyrolysis reactor 102 yield a high temperature fluid flow 120. Also, at such high pyrolyzation temperatures the yield of hydrocarbon feedstock in the form of methane 104 to pyrolysis-derived hydrogen 110 is high. In fact, when using methane 104, it is preferable that pyrolysis reactor 102 maintain temperature, pressure and internal conditions to ensure a hydrogen reaction yield of more than 70% hydrogen 110.

Chemical system 100 has a heat exchanger 122 that is connected to pyrolysis reactor 102 such that it receives high temperature fluid flow 120 of pyrolysis products 118 exiting pyrolysis reactor 102. In the present embodiment heat exchanger 122 is a counter-flow heat exchanger. More specifically still, counter-flow heat exchanger 122 is a dual-pipe heat exchanger.

Heat exchanger 122 has a channel or inner pipe 124 for admitting high temperature fluid flow 120 of pyrolysis products 118 through its hot inlet 126. In the context of heat exchangers, high temperature fluid flow 120 of pyrolysis products 118 is often referred to as the hot fluid by those skilled in the art. Its high temperature is denoted schematically in FIG. 1A by T_{p,in}, which indicates the high temperature of pyrolysis products 118 in high temperature fluid flow 120 or the hot fluid going into inner pipe 124 through hot inlet 126.

In the design of heat exchanger 122 inner pipe 124 folds twice and terminates with a cold outlet 128. A low temperature fluid flow 130 of pyrolysis products 118 is delivered from cold outlet 128 of inner pipe 124. In other words, heat exchanger 122 cools down high temperature fluid flow 120 that passes through inner pipe 124 by exchange of thermal energy described in detail below. The low temperature is denoted schematically in FIG. 1A by T_{p,out}, which indicates the low temperature of pyrolysis products 118 in low temperature fluid flow 130 or the cold fluid going out of inner pipe 124 through cold outlet 128 of heat exchanger 122.

Heat exchanger 122 has an external tube or outer pipe 132 that envelops or encloses inner pipe 124 along most of its length forming an annular space or gap about inner pipe 124. To accomplish this, outer pipe 132 also folds twice to match the geometry of inner pipe 124. Outer pipe 132 supports the counter flow of a working fluid flow 134. In other words, outer pipe 132 is designed to carry working fluid flow 134 in the opposite direction from that of pyrolysis products 118 moving through inner tube 124 from hot inlet 126 to cold outlet 128.

Outer pipe 132 has a work inlet 136 for admitting working fluid flow 134 at a low temperature and a work outlet 138 for releasing working fluid flow 134 at a high temperature. The high and low temperatures of working fluid flow 134 at work inlet 136 and work outlet 138 are also denoted schematically in FIG. 1A by T_{w,in} and T_{w,out}, respectively.

The view of the first and last portions of outer pipe 132 shows its interior in dashed lines such that the counter-flow of working fluid flow 134 in the annular gap around inner pipe 124 is revealed. This configuration maximizes the temperature difference between hot fluid 120 and cold or working fluid flow 134 along the length of heat exchanger 122 which is essential for efficient heat transfer.

To facilitate thermal energy exchange between hot fluid flow 120 and cold or working fluid flow 134 inner pipe 124 is typically made of thermally conductive material. A suitable material is a metal such as copper, aluminum, stainless steel, inconel, hastelloy or polymers with high thermal conductivity. Inner pipe 124 can also be made from refractory materials such as graphite, silicon carbide, and aluminum oxide. Thus, as hot fluid flow 120 passes through inner pipe 124, while cold or working fluid flow 134 passes in the opposite direction through outer pipe 132 heat is exchanged through the walls of inner tube 124.

Chemical system 100 is further equipped with a processing system 140 connected to heat exchanger 122. Processing system 140 receives low temperature fluid flow 130 of pyrolysis products 118, namely pyrolysis-derived hydrogen 110, solid carbon product 114 and hydrocarbon fraction 116. Because pyrolysis products 118 are at low temperature T_{p,out} their processing by processing system 140 is significantly simpler than if they had to be processed at high temperature T_{p,in} of high temperature fluid flow 120 exiting pyrolysis reactor 102.

Processing system 140 has a separator 142 for separating out solid carbon product 114. There are various types of separators that can be deployed as separator 142 in processing system 140. For example, separator 142 can be a solid filter such as a cyclone, a baghouse filter or a HEPA filter. In any of these cases, since separator 142 operates at low temperature it can be operated without any additional high-temperature provisions, as would be the case when operating at high temperatures.

In the embodiment shown in FIG. 1A separator 142 is a baghouse filter. A collection vessel 144 is positioned below a bottom outlet 146 of baghouse filter 142 for collecting solid carbon product 114 separated from pyrolysis products 118 carried in low temperature fluid flow 130. Preferably, over 60% of solid carbon product 114 is removed or separated by baghouse filter 142 from pyrolysis products 118 to yield a filtered low temperature fluid flow 130′ of a processed hydrogen gas 110′ that contains over 70% hydrogen and is visualized in highly magnified molecular form within a dotted and hatched outline to distinguish it from pyrolysis-derived hydrogen 110 obtained from pyrolysis reactor 106. Note that some hydrocarbon fraction 116 is usually present in filtered low temperature fluid flow 130′ exiting from baghouse filter 142 along with processed hydrogen gas 110′.

Processing system 140 has a second separator 148 for receiving filtered low temperature fluid flow 130′ of processed hydrogen gas 110′ from baghouse filter 142. Second separator 148 is preferably a gas filter such as a pressure or temperature swing absorption system, a distillation system or a membrane separator. Second separator 148 further purifies filtered low temperature fluid flow 130′ to remove particulate contaminants including hydrocarbon fraction 116 and still other particulates (not shown) whose presence is not desired. The output of second separator 148 is thus purified low temperature fluid flow 130″ of processed hydrogen gas 110′ mostly consisting of hydrogen at this point.

In general, processing system 140 can be equipped with many devices that take advantage of low temperature fluid flow 130 to perform additional useful functions. These additional functions can be performed on low temperature fluid flow 130 itself or on filtered and/or purified low temperature fluid flows 130′, 130″ of processed hydrogen gas 110′. These include separators beyond baghouse filter 142 such as auxiliary systems and devices to recycle unreacted hydrocarbon feedstock 104 and recycle heat from outlet products to inlet feedstock. Many such systems are well-known to a person skilled in the art and such auxiliary systems can be used in conjunction with pyrolysis reactor 102. Furthermore, hydrocarbon feedstock 104 as used herein includes hydrocarbons that may have already been purified, separated, mixed, or otherwise acted upon by auxiliary systems, as noted above.

In the present embodiment, processing system 140 has a compressor 150 for increasing the pressure of purified low temperature fluid flow 130″ suitable for its downstream uses. In particular, compressor 150 raises the pressure of purified low temperature fluid flow 130″ that consists mostly of processed hydrogen gas 110′ to between 1 and 1,000 bar absolute pressure. After reaching final pressure in compressor 150 purified low temperature fluid flow 130″ that is predominantly a gas flow of processed hydrogen gas 110′ at the desired low gas temperature is prepared to fulfill a dual function in accordance with the invention.

First, as processed hydrogen gas 110′ represents the final product a gas analyzer 152 is provided in processing system 140 for measuring a chemical composition and a purity of processed hydrogen gas 110′. This is done to ensure that processed hydrogen gas 110′ meets the requirements of a downstream application 154.

Second, since processed hydrogen gas 110′ is also used as cold fluid or working fluid flow 134 in heat exchanger 122 it is subject to additional conditioning before it can function as such. Specifically, to produce a gas flow of processed hydrogen gas 110′ suitable for use as working fluid flow 134 a monitoring or measurement device 156 is provided. In the simplest case, device 156 is a measuring device to confirm that the flow rate of gas flow of processed hydrogen gas 110′ is suitable for use and can be duly deployed as working fluid flow 134. Preferably, however, device 156 has the ability to not only measure but also to adjust the flow rate to ensure that the gas flow of processed hydrogen gas 110′ is indeed proper for its function as working fluid flow 134 in heat exchanger 122. Thus, device 156 can include a final compressor and auxiliary devices including ones that can regulate the operation of first and second separators 142, 148 to ensure that the gas flow of processed hydrogen gas 110′ can be used as working fluid flow 134. In fact, it is advantageous for device 156 to also control the operation of compressor 150 to control the absolute pressure of processed hydrogen gas 110′.

FIG. 1B affords a partial plan sectional view of heat exchanger 122 that better illustrates how the gas flow of processed hydrogen gas 110′ at adjusted flow rate is deployed as cold fluid or working fluid flow 134 in heat exchanger 122 according to the invention. For clarity of explanation, FIG. 1B leaves out several folded portions of heat exchanger 122 (see FIG. 1A). However, as indicated schematically, heat transfer takes place between high temperature fluid flow 120 of pyrolysis products 118 and cold fluid or working fluid flow 134 as these fluids flow past each other in opposite directions. The details of the heat exchange process will be addressed below.

Meanwhile, the partial view of FIG. 1B focuses on important segments of inner pipe 124 and outer pipe 132 that envelops or encloses inner pipe 124 to form the annular gap. In particular, FIG. 1B shows in detail the segment of inner pipe 124 that includes its hot inlet 126 where the hot fluid here constituted by high temperature fluid flow 120 of pyrolysis products 118 is admitted into inner pipe 124 at high temperature T_{p,in}. The path of high temperature fluid flow 120 is indicated schematically as it folds twice during its travel through heat exchanger 122.

FIG. 1B also shows in detail the segment of inner pipe 124 with its cold outlet 128. By the time high temperature fluid flow 120 passes through heat exchanger 122 it arrives at cold outlet 128 as low temperature fluid flow 130 of pyrolysis products 118, i.e., low temperature pyrolysis-derived hydrogen 110, solid carbon product 114 and hydrocarbon fraction 116. In particular, low temperature fluid flow 130 of pyrolysis products 118 exits cold outlet 128 at low temperature T_{p,out}.

FIG. 1B further shows in detail the segment of outer pipe 132 at work inlet 136 where working fluid flow 134 constituted by gas flow of processed hydrogen gas 110′ at low temperature T_{w,in} is admitted into the annular gap between outer pipe 132 and inner pipe 124. The path of working fluid flow 134 is indicated schematically as it folds twice during its travel through heat exchanger 122. Also shown in detail is the segment of outer pipe 132 with work outlet 138 for releasing working fluid flow 134 constituted by gas flow of processed hydrogen gas 110′ at high temperature T_{w,out}.

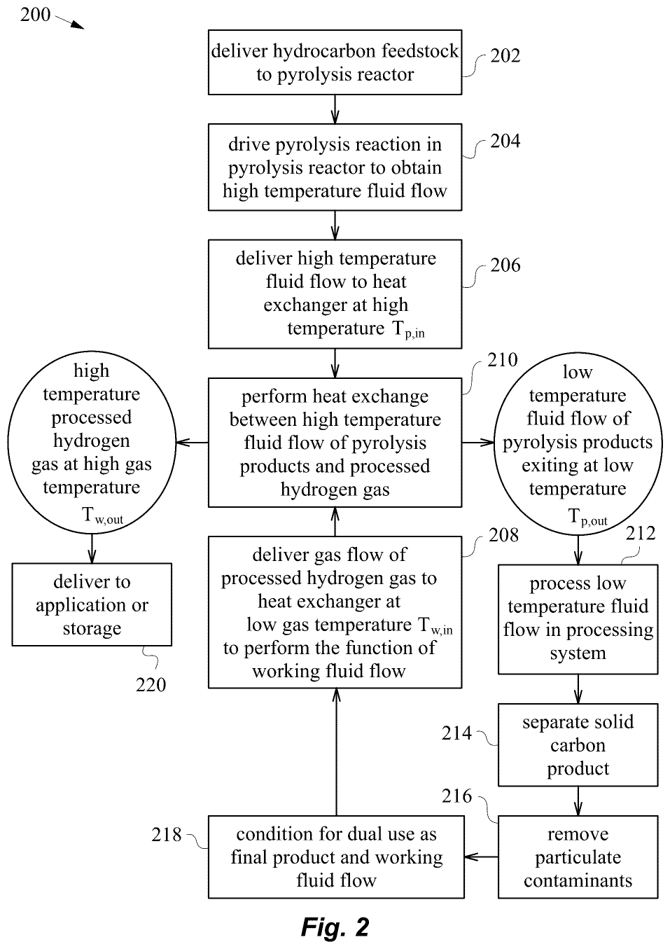

FIG. 2 is a flow diagram 200 that explains the operation of chemical system 100 and the heat exchange process taking place in heat exchanger 122. Flow diagram 200 makes reference to elements introduced in FIGS. 1A-B.

In a first step 202 hydrocarbon feedstock 104, which is methane (CH₄) in the present embodiment, is delivered to pyrolysis reactor 102. It is noted that methane in natural gas is a low-cost resource and can be obtained from any suitable existing natural gas infrastructure.

In a subsequent step 204, pyrolysis of hydrocarbon feedstock 104 is driven in pyrolysis reactor 102 in an oxygen-free environment. The energy for driving the pyrolysis reaction is provided by a power supply (not shown). Preferably, power for driving the pyrolysis reaction is derived from grid electricity or renewable electricity. Renewable electricity from hydro-electric, nuclear, or wind and solar with energy storage is an advantageous choice as power supply for pyrolysis reactor 102.

During step 204 pyrolysis reactor 102 pyrolyzes or performs pyrolysis of hydrocarbon feedstock 104 at temperatures between 500° C. and 2,000° C. As a result, high temperature fluid flow 120 of pyrolysis products 118 delivered by pyrolysis reactor 102 exits its bottom outlet 112 at temperatures between 500° C. and 2,000° C. Pyrolysis products 118 thus obtained essentially include solid carbon product 114, hydrocarbon fraction 116 and pyrolysis-derived hydrogen 110. Note that solid carbon product 114 is carried out of pyrolysis reactor 102 by high temperature fluid flow 120 which has a sufficient velocity to fluidize out solid carbon product 114. Further, it is preferable to operate pyrolysis reactor 102 to maintain a yield of hydrocarbon feedstock 104, here methane, to pyrolysis-derived hydrogen 110 greater than 70%.

Step 204 of pyrolyzing hydrocarbon feedstock 104 can also proceed in the presence of a catalyst. If step 204 is catalytic, then the pyrolysis can take place at temperatures as low as 400° C. However, to achieve higher yields it is preferred to proceed with catalytic pyrolysis of hydrocarbon feedstock 104 at temperatures over 1,000° C. Thus, solid carbon product 114 will not be significantly contaminated with the catalyst material. Typically, with catalytic pyrolysis the decomposition of hydrocarbon feedstock 104 occurs on the surface of a catalyst particle and solid carbon product 114 adheres to the surface of such catalyst particle. When such adhesion takes place, it can lead to deactivation of the catalyst and/or loss of the catalyst. If used in step 204, the catalyst should contain one of the transition metals such as Cobalt (Co), Ruthenium (Ru), Nickel (Ni), Rhenium (Re), Platinum (Pt), Copper (Cu), Tungsten (W), Iron (Fe) and Molybdenum (Mo) or compounds thereof. In embodiments where industrial application 154 of processed hydrogen gas 110′ and solid carbon product 114 produced in pyrolysis step 204 is iron and steelmaking, the catalyst can contain common steel alloying elements such as Manganese (Mn), Nickel (Ni), Chromium (Cr), Carbon (C) and Vanadium (V) as these are typically added in subsequent steelmaking to produce different grades of steel.

When step 204 involves non-catalytic pyrolysis, temperatures in excess of 1,100° C. are typically required to achieve higher yields of hydrocarbon feedstock 104 to solid carbon product 114 and hydrogen 110. Preferably, temperatures in excess of 1,200° C. and potentially as high as 2,000° C. are employed in step 204. Further information about thermochemical decomposition parameters of hydrocarbons suitable for use as hydrocarbon feedstock 104 is available in the literature. The reader is here referred to M. Wullenkrod, “Determination of Kinetic Parameters of the Thermal Dissociation of Methane”, Ph. D. Dissertation, Lehrstuhl fur Solartechnik (DLR), RWTH Aachen University, 2012 as well as S. Rodat et al., “Kinetic modelling of methane decomposition in tubular solar reactor”, Chemical Engineering Journal, 146 (2009), pp. 120-127.

In a following step 206, high temperature fluid flow 120 produced by performing pyrolysis in step 204 is delivered from pyrolysis reactor 102 to heat exchanger 122. More precisely, high temperature fluid flow 120 is delivered to heat exchanger 122 through hot inlet 126 of inner pipe 124. At this point in the process high temperature fluid flow 120 of pyrolysis products 118 is at high temperature T_{p,in}. Note that high temperature T_{p,in} generally corresponds to the temperature at which pyrolysis products 118 exit the reaction zone of pyrolysis reactor 102, i.e., between 500° C. and 2,000° C.

Furthermore, a large fraction (>33% and preferably >90%) of solid carbon product 114 is fluidized out of pyrolysis reactor 102 in high temperature fluid flow 120 in step 206. Thus, pyrolysis products 118 that are delivered primarily consist of hydrogen 110, solid carbon product 114 and a small hydrocarbon fraction 116 that did not decompose in pyrolysis reactor 102. Note that hydrocarbon fraction 116 will typically include methane as well as ethane, ethylene, acetylene and aromatic or polyaromatic hydrocarbons. If high temperature fluid flow 120 has sufficient velocity, then it will carry particles of solid carbon product 114 from pyrolysis reactor 102 and enable a continuous process. It is noted, however, that solid carbon product 114 can also be extracted by means other than fluidization such as mechanical extraction off the surface of pyrolysis reactor 102.

In step 208, which is carried out contemporaneously with step 206, gas flow of processed hydrogen gas 110′ duly conditioned to perform the function of cold fluid or working fluid flow 134 is delivered to heat exchanger 122. Specifically, working fluid flow 134 is delivered to heat exchanger 122 through work inlet 136 into the annular gap between outer pipe 132 and inner pipe 124. Working fluid flow 134 is at low gas temperature T_{w,in} at work inlet 136. The exact value of low gas temperature T_{w,in} is controlled in order to achieve the desired heat exchange between working fluid flow 134 and high temperature fluid flow 120 of pyrolysis products 118 in a subsequent step 210 involving heat exchange.

During step 210 heat exchange occurs between working fluid flow 134 and high temperature fluid flow 120 of pyrolysis products 118 inside heat exchanger 122. Preferably, heat exchanger 122 is configured to decrease high temperature T_{p,in} of high temperature fluid flow 120 to below 500° C. and even more preferably below 300° C. In other words, the desired low temperature T_{p,out} of low temperature fluid flow 130 of pyrolysis products 118 exiting cold outlet 128 of inner pipe 124 is below 500° C. and even more preferably below 300° C. Contemporaneously, it is preferred that the heat exchange process of step 210 achieve a heating of the gas flow of processed hydrogen gas 110′ acting as cold fluid or working fluid flow 134 to high gas temperature T_{w,out} at work outlet 138 that is above 300° C. or above 700° C.

In order to achieve these desired results in step 210 it is important that heat exchanger 122 be properly configured. Specifically, the advantageous dual use of processed hydrogen gas 110′ according to the invention as working fluid flow 134 and also as end product for application 154 requires careful balancing of thermal energy exchange conditions. In the preferred embodiment illustrated in FIGS. 1A-B, heat exchanger 122 is used to exchange thermal energy between pyrolysis products 118 and processed hydrogen gas 110′ in the counter-flow configuration. The key principle behind counter-flow heat exchanger 122 is that the two flows 120 and 134 flow in opposite directions. This arrangement allows for efficient heat transfer as high temperature fluid flow 120 and working fluid flow 134 enter heat exchanger 122 at opposite ends and flow in parallel but opposite directions within inner pipe 124 and outer pipe 132, respectively.

Heat transfer in counter-flow heat exchanger 122 primarily occurs through conduction across inner pipe 124. In particular, heat transfer by conduction is indicated schematically in FIG. 1B by arrows HT across wall portions 124A of inner pipe 124 where outer pipe 132 encloses it and where flows 120 and 134 flow past each other. Secondary heat transfer mechanisms include fluid mixing, turbulence and convection within each fluid flow 120, 134.

As hot fluid flow 120 and cold fluid or working fluid flow 134 move in opposite directions, there is a continuous exchange of thermal energy through wall portions 124A of inner pipe 124. This exchange causes hot fluid flow 120 to lose heat to working fluid flow 134, resulting in a temperature change in both flows. The counter-flow configuration maintains a temperature gradient along the length of heat exchanger 122. At hot inlet 126 hot fluid flow 120 is at its highest temperature, namely T_{p,in}, While at work inlet 136 working fluid flow 134 is at its lowest temperature, namely T_{w,in}. As flows 120, 134 counter-propagate the temperature of hot fluid flow 120 decreases, while the temperature of working fluid flow 134 increases. This results in efficient utilization of the temperature difference, maximizing heat transfer. Thus, heat exchange step 210 yields gas flow of processed hydrogen gas 110′ at high temperature T_{w,out} from work outlet 138 and low temperature fluid flow 130 of pyrolysis products 118 at low temperature T_{p,out} from cold outlet 128.

It is noted that counter-flow heat exchange is known for high thermal efficiency compared to other heat exchange configurations, such as parallel-flow or cross-flow exchangers. This efficiency is a result of the continuous improvement in the temperature difference between hot fluid flow 120 and working fluid flow 134 as they travel through heat exchanger 122. That is also one of the main reasons for preferably using the counter-flow geometry in the present invention.

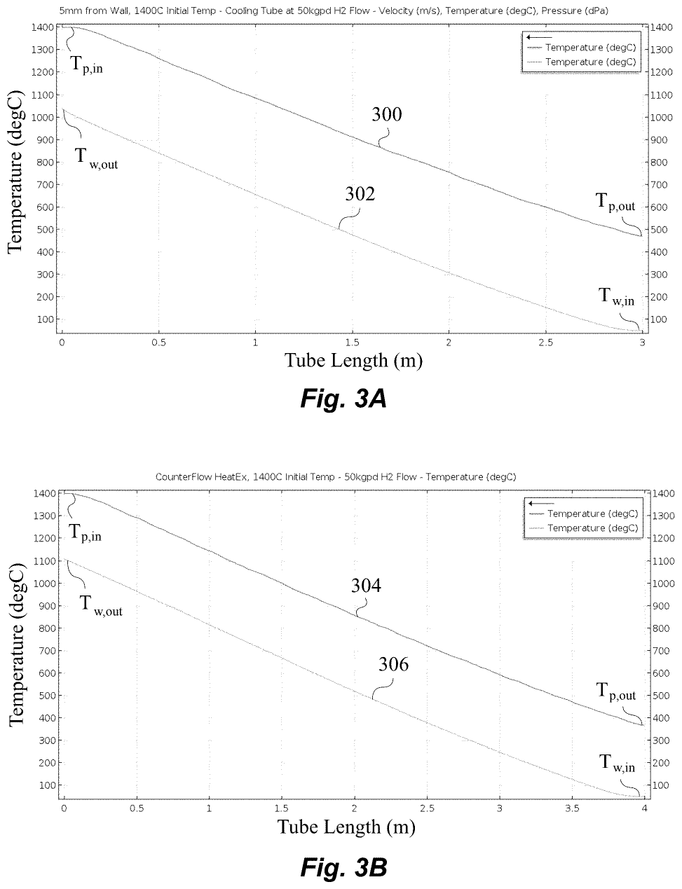

FIG. 3A is a thermal plot illustrating the heat exchange step 210 in a specific case where the length of wall portion 124A of inner pipe 124 through which heat exchange between hot fluid flow 120 and working fluid flow 134 takes place is 3 m. A temperature plot 300 illustrating the temperature variation in hot fluid flow 120 shows a significant drop from T_{p,in} at 1,400° C. down to T_{p,out} at 500° C. Meanwhile, a temperature plot 302 illustrating the temperature variation in working fluid flow 134 shows a significant rise from T_{w,in} at 25° C. up to T_{w,out} at 1,000° C. Note that working fluid flow 134 of processed hydrogen gas 110′ is compressed.

The change in temperature achieved in step 210 can be increased by increasing the length of wall portion 124A along which the heat exchange occurs. In the geometry of heat exchanger 122 this can be accomplished by extending that length with an additional fold. Alternatively, heat exchanger 122 can be lengthened in all three folds.

FIG. 3B is a thermal plot illustrating the heat exchange step 210 in the case where the length of wall portion 124A of inner pipe 124 through which heat exchange between hot fluid flow 120 and working fluid flow 134 takes place is extended to 4 m. A temperature plot 304 illustrating the temperature variation in hot fluid flow 120 shows a more significant drop from T_{p,in} at 1,400° C. down to T_{p,out} at 370° C. Meanwhile, a temperature plot 306 illustrating the temperature variation in working fluid flow 134 shows a more significant rise from T_{w,in} at 25° C. up to T_{w,out} at 1, 100° C. Again, note that working fluid flow 134 of processed hydrogen gas 110′ is compressed.

A significant benefit of the present invention is that the thermal mass of pyrolysis products 118 in hot fluid flow 120 and the processed hydrogen gas 110′ in working fluid flow 134 is roughly the same. This makes for efficient heat transfer between fluid flows 120 and 134. As seen from the thermal plots in FIGS. 3A-B processed hydrogen gas 110′ in working fluid flow 134 can easily reach temperatures over 1,000° C. Such temperatures are very desirable when application 154 is iron ore reduction. Another benefit of the present invention is that cooling down pyrolysis products 118 in hot fluid flow 120 to a temperature below 1,000° C. should effectively quench or stop the thermal decomposition reaction, such that any unreacted hydrocarbons leaving the pyrolysis reaction should not decompose in the downstream components of processing system 140 to leave behind carbon deposition that is hard to clean.

Returning to flow diagram 200 in FIG. 2 we continue to step 212 in which processed low temperature fluid flow 130 of pyrolysis products 118 at low temperature T_{p,out} that is below 500° C. and even below 300° C. is passed to processing system 140. Because low temperature T_{p,out} is so significantly reduced from high temperature T_{p,in} (possibly as high as 2,000° C.) step 212 is vastly simplified. That is because transporting and operating on low temperature fluid 130 at low temperature T_{p,out} and specifically on its constituent pyrolysis products 118 at this low temperature does not require cumbersome high-temperature provisions.

Subsequent step 214 of separating out solid carbon product 114 is carried out on low temperature fluid flow 130 within processing system 140. Step 214 preferably involves removal of most of solid carbon product 114 using separator 142. Preferably, over 60% of solid carbon product 114 is removed in step 214 to yield filtered low temperature fluid flow 130′ of processed hydrogen gas 110′ that contains over 70% hydrogen.

In step 216 filtered low temperature fluid flow 130′ is passed to second separator 148 which is a gas filter. Step 216 involves purification of filtered low temperature fluid flow 130′ to remove particulate contaminants including hydrocarbon fraction 116 still present at this point. The output of step 216 is thus purified low temperature fluid flow 130″ of processed hydrogen gas 110′ mostly consisting of hydrogen at this point.

In step 218 purified low temperature fluid flow 130″ is conditioned for its dual purpose as gas flow of processed hydrogen gas 110′ that serves as working fluid flow 134 in heat exchanger 122 and is also the final product. During step 218 compressor 150 increases the pressure of purified low temperature fluid flow 130″. The actual absolute pressure is preferably tuned such that the thermal mass of purified low temperature fluid flow 130″ is matched closely to that of hot fluid flow 120 of pyrolysis products 118. Also, the flow rate of purified low temperature fluid flow 130″ is adjusted by device 156 to achieve the desired residence time in heat exchanger 122 and thus reach the desired level of heat exchange with hot fluid flow 120. In the embodiments illustrated in FIGS. 3A-B the flow rate of both fluid flows 120, 134 is 50 kg-H₂/day which is approximately equivalent to 210 SLMP (standard liters per minute). The pressure of hot fluid flow 120 entering heat exchanger 122 is about 15 psi while the pressure of working fluid flow is about 450 psi.

Purified low temperature fluid flow 130″ of processed hydrogen gas 110′ is also checked for its chemical composition in step 218. The chemical composition is important for application 154. Preferably, device 156 tunes the operation of separators 142, 148 of processing system 140 to achieve the desired chemical composition. In fact, further elements including auxiliary filters can be present in processing system 140 to aid in controlling the chemical composition of purified low temperature fluid flow 130″.

Once duly adjusted in chemical composition, flow rate and pressure, low temperature fluid flow 130″ of processed hydrogen gas 110′ is passed from step 218 to step 208. As explained above, in step 208 low temperature fluid flow 130″ is treated as working fluid flow 134 arriving at low temperature T_{w,in} (e.g., 25° C. in the present embodiment).

Flow diagram 200 also shows high temperature processed hydrogen gas 110′ exiting heat exchanger 122 outer pipe 132 at work outlet 138. At this point processed hydrogen gas 110′ is at high temperature T_{w,out} (e.g., 1,000° C. or even 1,100° C. depending on the length of wall portion 124A through which heat exchange occurs).

In step 220 the hot processed hydrogen gas 110′ is passed to application 154. High temperature processed hydrogen gas 110′ has many industrial uses. The desired delivery purity, pressure and temperature of processed hydrogen gas 110′ will vary depending on specific application 154. Correspondingly, these parameters are adjusted in processing system 140 when application 154 is specified.

A table of different industrial sectors which can use processed hydrogen gas 110′ and their desired delivery purity, pressure, and temperature is shown in Table 1 below.

TABLE 1

| | Use of | | | |
|---|---|---|---|---|
| | processed | | | |
| Application | hydrogen | Delivery | Delivery | Delivery |
| (Sector) | gas | purity | pressure | temperature |
| Combustion | | | | |
| Cement/Steel | combustion | low | low | low/medium |
| District | combustion | low | low | low/medium |
| heating/boilers | | | | |
| Transportation | | | | |
| Electric cars | fuel cell | high | high | low |
| Fork lifts | fuel cell | high | high | low |
| Trucks | fuel cell | high | high | low |
| Cargo ships | combustion/ | medium/high | high | low |
| | fuel cell | | | |
| Planes | combustion/ | medium/high | high | low |
| | fuel cell | | | |
| Chemicals | | | | |
| Methanol | combine | medium | medium | low/medium |
| | with CO₂ | | | |
| F-T Fuels | combine | medium | medium | low/medium |
| | with CO₂ | | | |
| Ammonia | combine | high | high | low/medium |
| | with N₂ | | | |
| Plastics | combine | medium | medium | low/medium |
| | with CO₂ | | | |
| Chemical | | | | |
| Reduction | | | | |
| Petrochemical | reducing | medium | medium | medium |
| refining | agent | | | |
| Hydrocracking | reducing | medium | medium | medium |
| | agent | | | |
| Hydro- | reducing | medium | medium | medium |
| desulfurization | agent | | | |
| Iron ore | reducing | medium | medium | high |
| reduction | agent | | | |
| Nickel ore | reducing | medium | medium | high |
| reduction | agent | | | |
| (batteries) | | | | |
| Metal reduction | reducing | medium | medium | high |
| (Si, Zn, Cu, | agent | | | |
| Sn, Pb, Ni, Co) | | | | |

For delivery purity, low, medium, and high purity are roughly 80-95%, 95-99.5%, and 99.5-99.999% hydrogen content in processed hydrogen gas 110′, respectively. Low, medium, and high delivery pressure are roughly 1-2 bar, 2-100 bar, and 100-1000 bar, respectively. Low, medium, and high delivery temperatures are roughly 0-50° C., 50-400° C., and >400° C., respectively. These values are just for reference and any of the sectors could use processed hydrogen gas 110′ at any purity, pressure, and temperature as it is desired.

In order for processed hydrogen gas 110′ to be suitable for industrial applications 154 such as for iron and steelmaking, chemical production, fuels, or heating, some fraction or all of solid carbon product 114 needs to be separated in separator 142 of processing system 140. For iron and steelmaking applications 154, it is possible that a larger fraction, up to 508, of solid carbon product 114 may be desirable to introduce into the ironmaking process for carburization. Thus, for such applications 154 separator 142 of processing system 140 should not separate out more than 50% of solid carbon product 114.

However, for most other applications 154 of processed hydrogen gas 110′, it is desirable for the vast majority of solid carbon product 114 to be removed by separator 142 of processing system 140 from pyrolysis gasses 118. Note, it is often the case that the separation of solid carbon product 114 is critical to minimize the formation of carbon dioxide from chemical system 100. Some fraction of solid carbon product 114 will be fluidized out of pyrolysis reactor 102 with pyrolysis products 118 as the drag force is sufficient to overcome the weight of the particles and causes them to be carried with high temperature fluid flow 120. If the gas were to be kept at high temperatures for downstream processing, hydrogen 110 would need to be purified of carbon and other gaseous components present in high temperature fluid flow 120 at the high temperatures, which is difficult, as mentioned above.

It should be noted that flow diagram 200 of FIG. 2 illustrates the operation of chemical system 100 that is already running. In the event of a cold start of chemical system 100 a previously stored compressed hydrogen or an inert gas such as N₂ or Argon can be used during the start-up phase before the process shown in flow diagram 200 is running as shown and described.

The chemical system and method of the present invention admit of various alternative embodiments. In particular, different types of counter-flow heat exchangers can be used instead of the dual-pipe geometry heat exchanger 122 described above.

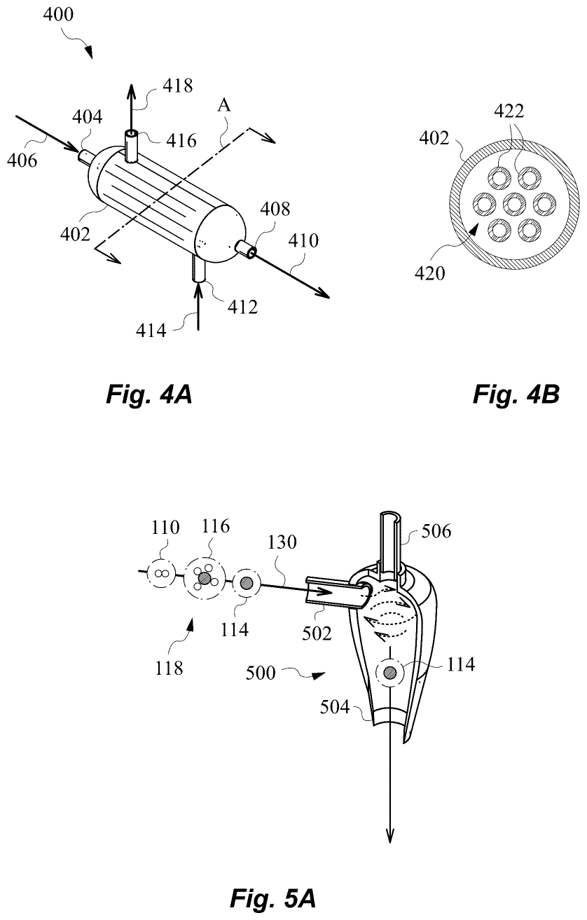

FIG. 4A illustrates an alternative counter-flow heat exchanger 400 that can be deployed in chemical system 100 or in an alternative embodiment. Heat exchanger 400 is a shell-and-tube type heat exchanger. Heat exchanger 400 has a shell 402 with a hot inlet 404 for admitting hot fluid flow 406 and a cold outlet 408 for delivering cold fluid flow 410. Heat exchanger 400 also has a work inlet 412 for admitting work fluid flow 414 and a work outlet 416 for releasing work fluid flow 418. Line A indicates the cross-sectional cut of the view through shell 402 of heat exchanger 400 illustrated in FIG. 4B.

FIG. 4B shows the internal geometry of shell 402 where hot fluid flow 406 coming in through hot inlet 404 (see FIG. 4A) is distributed to a number of tubes 422. Thus, in counter-flow shell-and-tube heat exchanger 400 hot fluid flow 406 passes through tubes 422 while work fluid flow 414 passes in the opposite direction on the outside of tubes 422 inside of shell 402 in the region designated with reference numeral 420 in FIG. 4B.

Now, it is preferred to have high temperature fluid flow 120 consisting of lower pressure pyrolysis products 118 travel through inner pipe 124 in the case of heat exchanger 122, as discussed and shown above. One of the main reasons for this is that such configuration reduces the cooling and insulation requirement on outer pipe 132. That is because even at its high temperature T_{w,out} reached at work outlet 138 processed hydrogen gas 110′ will still be at a lower temperature than high temperature T_{p,in} (possibly up to 2,000° C.) of high temperature fluid flow 120 of pyrolysis products 118. The same holds when using shell-and-tube heat exchanger 400. Therefore, it is also preferred that hot fluid flow 406 proceed through tubes 422 while enveloped in counter-propagating work fluid flow 414 passing through region 420 within shell 402.

In some embodiments, however, it is preferred to have work fluid flow 134 of lower temperature higher pressure processed hydrogen gas 110′ flow inside inner pipe 124 or inside tube or tubes 422. This is done in order to maintain tensile stresses on inner pipe 124 or inside tube or tubes 422 as their cross-sectional area may be easily designed to be smaller than the annular area of outer pipe 132 or of shell 402.

This design allows for similar mass flow rates of the higher pressure processed hydrogen gas 110′ and lower pressure pyrolysis products 118. Ultimately, the preferred heat exchanger design and geometry will depend on the temperature and pressure of pyrolysis products 118 as well as the temperature and pressure of desired processed hydrogen gas 110′. It is noted that these temperatures and pressures will differ for each application 154. The corresponding adaptations to the design of heat exchangers that are best suited for any given chemical system of the invention will be well-known to a person skilled in the art.

In still another embodiment a plate heat exchanger can be deployed in chemical system 100 or another embodiment of the chemical system of invention. The advantage of using plates is that the hot and cold fluid flows are exposed to a much larger area because they are spread out over the plates. This facilitates the heat transfer process and also greatly increases the rate of temperature change as the fluids counter-propagate past each other.

The chemical system and method of the present invention are also subject to additional variants and modifications based on application 154 and its requirements. In the present invention pyrolysis products 118 refers to hydrogen 110, solid carbon product 114 and hydrocarbon fraction 116 that can include various gasses and carbon particulates that are leaving the pyrolysis reaction zone of pyrolysis reactor 102 where the pyrolysis reaction is performed. Pyrolysis products 118 are processed in processing system 140 to obtain processed hydrogen gas 110′, which refers to a gas stream which contains primarily hydrogen gas, but may also contain unreacted hydrocarbon gasses such as methane, ethane, ethylene, acetylene, and benzene as well as solid carbon particulates. However, such components may actually be desirable for application 154. For example, when processed hydrogen gas 110′ is used as a reducing agent or for chemical production, residual methane in the processed hydrogen gas 110′ is acceptable or sometimes considered inert. In these applications residual hydrocarbon fraction 116 that is acceptable may be up to 20%. However, it is preferable in many applications for this residual hydrocarbon fraction 116 to be reduced as much as possible, especially when minimal carbon dioxide emissions are preferred. Similarly, residual solid carbon particulates may be acceptable in processed hydrogen gas 110′, up to >40% by mass of the original carbon produced by pyrolysis. However, again, it is typically preferred to remove the solid carbon from pyrolysis products 118 such that processed hydrogen gas 110′ can be obtained which can be used to avoid the formation of carbon dioxide emissions. Also, processed hydrogen gas 110′ may optionally be compressed to a desired delivery pressure with a compressor.

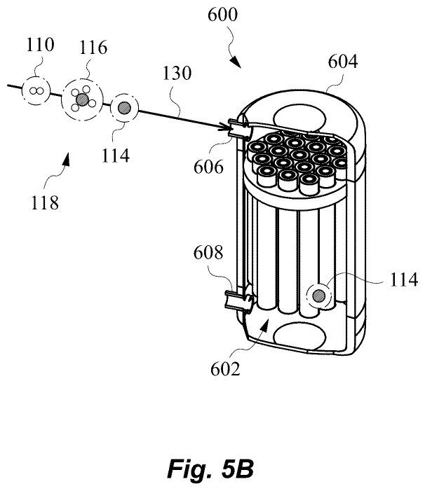

In still other embodiments, processing system 140 can deploy different types of separators. For example, a cyclone 500 as shown in FIG. 5A can be used to separate solid carbon product 114 and carbon particulates from low temperature fluid flow 130 of pyrolysis products 118. The design of cyclone 500 for solid-gas separation is well understood in the prior art. In particular, pyrolysis products 118 that include solid carbon product 114 enter cyclone 500 through cyclone inlet 502. Inside cyclone 500 pyrolysis products 118 rotate around a central outlet tube 504 at lower pressure, as shown. The majority of solid carbon product 114 will drop out of the bottom of cyclone through outlet 506 with gravity. Remaining gasses containing pyrolysis products 118 will exit through central outlet tube 504 upwards. The diameter of cyclone inlet 502 and outlet tube 504 and the pressure drop through cyclone 500 are key parameters in determining the separation efficiency. The efficiency in this case is a measure of how efficiently solid particles are separated from the gas stream. Typically, larger particles are much easier to separate than smaller particles. A series of cyclones can be used to ensure the separation of the majority of the solid carbon product 114. Cyclone design parameters and their optimization are well-known to those skilled in the art.

It should be noted that in the prior art a high-temperature cyclone would need to be used to maintain hydrogen 110 at high temperature. Such high-temperature cyclone would need to be well insulated and refractory-lined to maintain the pyrolysis gasses at temperatures >900° C. All piping would need to have a refractory lining on the interior to transport the pyrolysis gas and carbon at high temperature, adding complexity. A challenge to using a cyclone at high temperatures is that the solid carbon particulates can abrade the refractory surfaces and lead to degradation over time. Clearly, the present invention presents the advantage of operating on low temperature fluid flow 130 of pyrolysis products 118 and thus avoids these high-temperature challenges.

Processing system 140 can also deploy a candle filter 600 as shown in FIG. 5B to separate out solid carbon product 114. Candle filter 600 is a type of filtration device that uses cylindrical filter elements 602, commonly referred to as candles, to remove impurities and particles from low temperature fluid flow 130 of pyrolysis products 118. Candles 602 typically consist of a porous media, such as ceramic, metal, or polymer, that allows low temperature fluid flow 130 to pass through while capturing solid particles such as solid carbon product 114 or contaminants. Candles 602 are arranged vertically within a housing 604, and low temperature fluid flow 130 of pyrolysis products 118 to be filtered is admitted into candle filter through inlet 606. From there it is passed through candles 602 from the outside to the inside, allowing the contaminants and in the present case solid carbon product 114 to be trapped on the outer surface of candles 602. Meanwhile, the remainder of low temperature fluid flow 130 of pyrolysis products 118 leaves candle filter 600 through an outlet 608.

The trapped particles build up on the surface of candles 602, forming a filter cake, which can be periodically removed through cleaning or replacement of candles 602. Candle filters are commonly used in various industrial applications, including wastewater treatment, chemical processing, and pharmaceutical manufacturing, due to their high efficiency, low maintenance, and cost-effectiveness. The maximum operating temperature of candle filter 600 depends on the material of the filter element and the type of fluid or gas being filtered. For example, ceramic candle filters can typically operate at temperatures up to 900-1,000° C. A ceramic like silicon carbide is preferably used in order to enable operation at temperatures >900° C. However, the maximum temperature can be limited by the design of housing 604 and the seals used, which may not be able to withstand extreme temperatures. Additionally, certain fluids or gasses may contain components that can corrode or erode filter elements 602, reducing its effectiveness or causing it to fail prematurely.

Candle filters have several limitations that may make their usage challenging. The filter cake that forms on the surface of the candles can cause pressure drop and reduce flow rates, which may require frequent cleaning or replacement of the filter elements. Cleaning is often done with reverse air pulse systems. Operating a reverse air pulse in a high temperature environment that includes hydrogen 110 is challenging due to materials of construction for safe operation to prevent combustion or explosion of the hydrogen-containing gas environment. An inert or hydrogen air pulse will be needed, which will dilute and cool down the pyrolysis product gas stream. Most high temperature ceramic or metal candle filters are not as efficient as low temperature (<250° C.) polymer candle or bag filters at removing very small particles of <1-5 um that may exist within pyrolysis product streams. Candle filters may not be suitable for fluids or gasses that contain high concentrations of solids, as this can quickly clog the filter elements. Finally, the cost of candle filters can be higher compared to other types of filtration devices, particularly for applications that require high-temperature or corrosion-resistant materials.

Clearly, the handling of pyrolysis gasses while at high temperatures poses problems for further purification and compression. Thus, once again, the present invention presents the advantage of operating on low temperature fluid flow 130 of pyrolysis products 118 and thus avoids the high-temperature challenges. The present invention is further focused on utilizing the thermal energy in pyrolysis products 118, while enabling purification and compression to make the gasses produced from pyrolysis suitable for industrial application 154 such as process heat, transportation, chemical production, and chemical reduction.

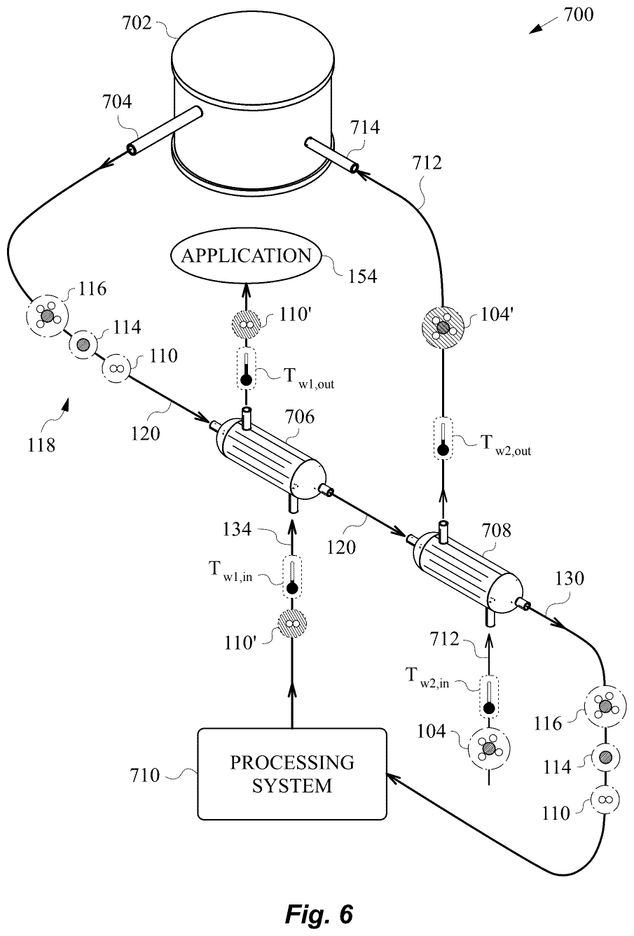

FIG. 6 is a schematic diagram of another embodiment of a chemical system 700 that deploys a liquid metal containing pyrolysis reactor 702. Analogous parts and elements in this embodiment are called out with previously used reference numerals for clarity.

Pyrolysis reactor 702 has an outlet 704 for releasing high temperature fluid flow 120 of pyrolysis products 118. Pyrolysis products 118 consist primarily of pyrolysis-derived hydrogen 110, pyrolysis carbon product or solid carbon product 114 and hydrocarbon fraction 116. Furthermore, pyrolysis reactor 702 preferably operates such that solid carbon product 114 is fluidized out of pyrolysis reactor 702 with pyrolysis products 118, as in the previous embodiment.

Chemical system 700 has a first heat exchanger 706 and a second heat exchanger 708 arranged in series. Both heat exchangers 706, 708 are counter-flow type. Further, they are configured such that high temperature fluid flow 120 of pyrolysis products 118 passes through first heat exchanger 706 and then through second heat exchanger 708. Thus, low temperature fluid flow 130 or the cold fluid issues from second heat exchanger 708.

Low temperature fluid flow 130 of pyrolysis products 118 is passed from second heat exchanger 708 to a processing system 710. As in the previous embodiments, processing system 710 can deploy various devices and elements (not expressly shown). In particular, processing system 710 has separators for separating out solid carbon product 114 as well as gas filters for removing hydrocarbon fraction 116 and any other undesired contaminants. Furthermore, processing system 710 has compressors and other devices for delivering processed hydrogen gas 110′ that preferably contains over 70% hydrogen and is visualized in highly magnified molecular form within a dotted and hatched outline to distinguish it from pyrolysis-derived hydrogen 110 obtained from liquid metal containing pyrolysis reactor 702.

Once again, in accordance with the invention processed hydrogen gas 110′ serves a dual purpose. It is deployed as working fluid flow 134 in first heat exchanger 706 to cool down high temperature fluid flow 120 of pyrolysis products 118. It is also the final product that is delivered from heat exchanger 706 to application 154.

In the present application, low temperature gas flow of processed hydrogen gas 110′ is used as working fluid flow 134 in first heat exchanger 706. Its low temperature is T_{w1,in} and its high temperature or the temperature at which it is delivered to application 154 is T_{w1,out}. The heat exchange between working fluid flow 134 and high temperature fluid flow 120 of pyrolysis products 118 inside first heat exchanger 706 is configured to decrease high temperature of high temperature fluid flow 120 to below 500° C. and even more preferably below 300° C. In other words, the desired low temperature of high temperature fluid flow 120 of pyrolysis products 118 exiting first heat exchanger 706 is below 500° C. and even more preferably below 300° C. As in the previous embodiment, this can be achieved with working fluid flow 134 entering first heat exchanger 706 at low temperature T_{wi,in} near 25° C. and exiting at high temperature T_{wi,out} at 1,000° C. or even above.

Chemical system 700 uses second heat exchanger 708 to further cool high temperature fluid flow 120. In other words, second heat exchanger 708 is designed to further lower the temperature of low temperature fluid flow 130 that it outputs to below 300° C. and preferably even below 200° C. This is accomplished by using a flow 712 of hydrocarbon feedstock 104 as working fluid in second heat exchanger 708. Flow 712 originates from the source (not shown) of hydrocarbon feedstock 104 and is appropriately conditioned for its function as working fluid (flow rate and pressure tuning).

The use of flow 712 of hydrocarbon feedstock 104 as working fluid in second heat exchanger 708 has two benefits. First, since hydrocarbon feedstock 104 is typically available at low temperature T_{w2,in} that is at or below 25° C. it is well suited for further cooling of high temperature fluid flow 120 to below 200° C. Second, the pre-heating of hydrocarbon feedstock 104 in second heat exchanger 708 prior to its pyrolysis in pyrolysis reactor 702 is energy efficient. Pre-heated hydrocarbon feedstock 104′ at a high temperature T_{w2,out} close to 300° C. will reach the desired pyrolysis temperature with less energy input into pyrolysis reactor 702 to drive pyrolysis. Pre-heated hydrocarbon feedstock 104′ being delivered to an input 714 of pyrolysis reactor 702 is shown in FIG. 6 in highly magnified molecular form within a dotted and hatched outline to distinguish it from hydrocarbon feedstock 104 that is cold. It should be noted that more than one heat exchanger can be used to exchange heat between pyrolysis products 118 and flow 712 of hydrocarbon feedstock 104.

The advantage of reducing the temperature of pyrolysis products 118 in low temperature fluid flow 130 to below 200° C. has many advantages. Low-cost elastomer seals and be used to seal between components in any part of processing system 710 at such low temperature. In alternative variants or embodiments of chemical system 700 when even further temperature reduction is desired more heat exchangers can be added in series. Such additional heat exchangers can use air, steam, water, a molten metal or salt as working fluid to cool pyrolysis products 118 even further. In fact, the series of heat exchangers in such alternative embodiments can be used to exchange heat between pyrolysis products 118 and flows of processed hydrogen gas 110′. It is well-known to one skilled in the art that heated air, water, steam, molten metals or salts can be used in a variety of applications, including but not limited to Rankine cycle for energy generation from waste heat, steam turbines to generate electricity, boilers for process heat or district heating.

Another advantage of using first heat exchanger 706 in series with second heat exchanger 708 is that once pyrolysis products 118 have been cooled down below 760° C., i.e., after exiting first heat exchanger 706, stainless steel tubing may be used to transport them. However, a temperature below 400° C. may be preferable before tubing made of materials containing catalytic materials are used. It is readily apparent to one skilled in the art that the order of any of the heat exchangers could be interchanged to vary the temperature of pyrolysis products 118 and the heat exchanging flows at the inlet and outlet of each heat exchanger. For example, in one alternative embodiment, a steam jacketed heat exchanger could be used as first heat exchanger 706 at outlet 704 of pyrolysis reactor 702 to reduce the temperature of pyrolysis products 118 to <1,100° C. and produce superheated steam while maintaining heat exchanger walls at temperatures at which common metal-based materials of construction can be used. Downstream, another heat exchanger could be used to exchange heat between pyrolysis products 118 at 1,100° C. and processed hydrogen gas 110′. Such embodiment preferred if the stream of processed hydrogen gas 110′ does not need to achieve temperatures >1,000° C. However, if temperatures >1,000° C. are required, then it would be preferred to use first heat exchanger 706 to exchange heat between pyrolysis products 118 and processed hydrogen gas 110′ stream first, followed by additional heat exchangers downstream after pyrolysis products 118 have been cooled by first heat exchanger 706.

Now that pyrolysis products 118 have been cooled down, it is easier to make seals between any processing equipment and use common piping materials such as stainless steel, copper, and aluminum. Therefore, processing system 710 and any auxiliary or additional systems that could not have been used due to the high temperatures can now be deployed as part of processing system 710 or in addition to it. These alternative embodiments enabled by the invention are described below.

Carbon particulate is removed from pyrolysis products 118 in processing system 710 to reach a desired hydrogen purity by using any of the above-described separation apparatus and methods such as cyclone separation, electrostatic precipitation, baghouse filtration, mechanical filtration with screens and meshes, wet, dry, and venturi scrubbers, and pneumatic separation. Importantly, a high efficiency particulate air (HEPA) filter can be used to remove very small particulates of carbon from the stream of pyrolysis products 118. HEPA filters are designed to capture particles as small as 0.3 micrometers (μm) with an efficiency of at least 99.97%. While there are high temperature ceramic filters, most HEPA filters are made from a dense, randomly arranged web or mat of fibers made from materials like fiberglass, paper, or synthetic materials, which are not stable at high temperatures. Thus, the present invention enables the usage of fine particulate filtration. Particulate filtration methods at temperatures below 300° C. and especially below 200° C. are well-known to those skilled in the art, and it is readily apparent that any of the methods listed above and others can be used or combined to achieve desired composition of pyrolysis product 118 and solid carbon product 114 separation and solids removal.

In another embodiment in which low temperatures are reached in accordance with the invention, solid carbon product 114 can be further purified using various solids purification processes. Suitable purification processed include hydrometallurgical processes such as filtration, centrifugation, flotation, precipitation, and sedimentation, mechanical processes such as sieving, magnetic separation, electrostatic separation, and air separation, and thermal processes such as evaporation and sublimation, and chemical processing such as leaching. It may be beneficial to use solids purification processes in order to create a more commercially viable product that requires low contamination or specific particle sizes. It may also be necessary to purify solid carbon product 114 in the case where it is contaminated with a molten salt or metal and possibly needs to be purified so that it can be safely disposed of. Such solids purification processes are well-known to those skilled in the art, and it is readily apparent to one skilled in the art that any of the methods or processes described above and others can be used or combined to achieve a purified solid carbon product 114. In still another embodiment, a solid carbon purification process uses a thermal purification process, for which at least a small fraction >10% of the thermal energy required is supplied using a heat exchanger to exchange heat from pyrolysis products 118.

In many applications of hydrogen, it is desirable to remove hydrocarbons such as methane, ethane, ethylene, acetylene, and benzene from pyrolysis products 118 to obtain a largely pure gas stream of processed hydrogen gas 110′. Additionally, it is often preferred to remove sulfur-containing compounds such as hydrogen sulfide, sulfur dioxide, and sulfides from pyrolysis products 118. Pressure swing adsorption (PSA) is the most commonly used industrial gas separation method, where varying pressure levels are used to selectively adsorb and desorb gasses on solid adsorbents, allowing for the separation of different gasses. A PSA could effectively purify the pyrolysis products to achieve a hydrogen purity exceeding 99%. In other embodiments, other gas separation methods such as absorption, distillation, cryogenic distillation, membrane separation, temperature swing adsorption, chemisorption, scrubbing, and catalytic conversion are used to purify pyrolysis products 118 to obtain a purified stream of processed hydrogen gas 110′.

In another embodiment, pyrolysis products 118 are compressed in a compressor to obtain processed hydrogen gas 110′ at a desired delivery pressure. Compressors take in a low-pressure gas such as pyrolysis products 118 or the purified and processed hydrogen gas 110′ at their inlet and then use mechanical energy to reduce the volume of the gas, thereby increasing its pressure. The compressed gas is discharged at a higher pressure compared to the inlet pressure. The main types of gas compressors include: (1) positive displacement compressors, (2) dynamic compressors or turbocompressors, (3) ejector compressors, (4) scroll compressors, and (5) liquid ring compressors. (1) Positive displacement compressors operate by trapping a fixed amount of gas in a chamber and then reducing the volume of that chamber to compress the gas. There are two primary types: reciprocating and rotary screws.

Reciprocating compressors use a piston and cylinder mechanism to compress gas. They are commonly used for low-to-medium-pressure applications and are suitable for intermittent operation. Rotary screw compressors use rotating screws to trap and compress gas and are known for their continuous, efficient operation. (2) Dynamic compressors, also known as turbocompressors, operate by imparting kinetic energy to the gas and then converting it into pressure energy. There are two main types: centrifugal and axial. Centrifugal compressors use a rotating impeller to accelerate the gas to high speeds, and then the kinetic energy is converted into pressure as the gas passes through a diffuser. Axial compressors have a series of rotating and stationary blades that compress gas in a continuous flow. (3) Ejector compressors use a high-speed jet of gas to entrain and compress another gas. They are often used in applications where there are specific requirements for mixing gasses or creating a vacuum. (4) Scroll compressors use two spiral-shaped scrolls, one stationary and one orbiting, to compress gas. (5) Finally, liquid ring compressors use a rotating impeller in a liquid ring to compress gas. They are often used in applications where a non-pulsating flow is required. Different types, sizes and arrangements of compressors, including multiple compressors in series or in parallel will be optimal depending on application 154 and its desired pressure and temperature of compressed processed hydrogen gas 110′. Types of compressors suited to each application and their arrangements will be known to those skilled in the art.

A significant benefit of compressing pyrolysis products 118 downstream of pyrolysis reactor 702 is that pyrolysis reactor 702 does not need to be operated at high pressure. In many industrial chemical applications, it is advantageous to operate pyrolysis reactor 702 at high pressure as it may increase the reaction yield or rate such as an ammonia synthesis. However, in methane pyrolysis, since more moles of gas are being produced in the reaction, the reaction yield decreases with increasing pressure according to Le Chatelier's Principle. Thus, it is desirable from a yield perspective to operate closer to atmospheric pressure. Additionally, operating close to atmospheric pressure means that pyrolysis reactor 702 of any type including a furnace does not need to be or be contained by a pressure vessel, which adds engineering complexity.

Another benefit of the present invention is that by cooling down pyrolysis products 118 prior to compression, a wider range of compressors may be used. It is difficult to compress a gas at high temperature, especially above 300° C., as the seals, coolants, lubricating oils, and materials of construction become more difficult. At high temperatures, an ejector compressor would likely need to be used such that the gas is compressed by the inertial force of another gas rather than a solid or liquid medium.

In some embodiments, processed hydrogen gas 110′ which has been processed with purification and compression is analyzed or measured prior to being delivered to application 154 such as an industrial process. For example, the flow rate of processed hydrogen gas 110′ is measured with a flowmeter. The flowmeter can be chosen from among various types such as: orifice plate, venturi tube, rotameter, thermal mass, differential pressure, ultrasonic, vortex shedding, Coriolis, turbine, positive displacement, and inferential flowmeters. In some embodiments, the chemical composition and purity of processed hydrogen gas 110′ is analyzed. Examples of gas analysis techniques which could be used in the present invention include: gas chromatography, mass spectroscopy, infrared spectroscopy, UV-Visible spectroscopy, flame ionization detector coupled spectroscopy, with mass thermal conductivity detection, photoionization detection, gas sensors, and gas analyzers.

Finally, particulate removal, solid regarding gas or carbon purification, gas or solid measurement, and compression equipment, processes, and systems we note that these are well-known to those skilled in the art. Therefore, it will be readily apparent to one skilled in the art that any of the equipment, methods, or systems described above and others can be used or combined to achieve processed hydrogen gas 110′ in a stream at temperatures <300° C. or more preferably less than 200° C. Importantly, it will be readily apparent to one skilled in the art that additional particulate removal, gas purification, and compression methods and other gas processing and measurement processes and equipment not explicitly stated above can be used to achieve a processed hydrogen gas stream as described here. For example, process gas blowers and fans are additional equipment and process items that would be applicable to processing the processed hydrogen gas stream described here.

It will be evident to a person skilled in the art that the present invention admits of various other embodiments. Therefore, its scope should be judged by the claims and their legal equivalents.

1. A chemical system for producing a processed hydrogen gas at a high gas temperature, said chemical system comprising:
a) a pyrolysis reactor for pyrolyzing a hydrocarbon feedstock to produce a high temperature fluid flow of pyrolysis products containing primarily hydrogen and a solid carbon product;
b) a heat exchanger connected to said pyrolysis reactor for receiving said high temperature fluid flow of said pyrolysis products and delivering a low temperature fluid flow of said pyrolysis products;
c) a processing system connected to said heat exchanger for:
1) receiving said low temperature fluid flow of said pyrolysis products;
2) processing said pyrolysis products to obtain said processed hydrogen gas at a low gas temperature;
3) delivering a gas flow of said processed hydrogen gas at said low gas temperature to said heat exchanger;
whereby said heat exchanger exchanges heat between said high temperature fluid flow of said pyrolysis products and said gas flow 18 of said processed hydrogen gas at said low gas temperature to cool said high temperature fluid flow and to heat said gas flow at said low gas temperature to produce said processed hydrogen gas at said high gas temperature.

2. The chemical system of claim 1, wherein said hydrocarbon feedstock substantially comprises methane or natural gas and solid carbon product comprises solid carbon.

3. The chemical system of claim 1, wherein said pyrolysis reactor pyrolyzes said hydrocarbon feedstock at temperatures between 500° C. and 2,000° C.

4. The chemical system of claim 1, wherein a fraction of said solid carbon product is fluidized out of said pyrolysis reactor by said high temperature fluid flow of said pyrolysis products.

5. The chemical system of claim 1, wherein said processing system comprises a separator for separating out over 60% of said solid 2 carbon product from said low temperature fluid flow of said 3 pyrolysis products to yield said processed hydrogen gas 4 containing over 70% hydrogen.

6. The chemical system of claim 5, wherein said separator comprises a solid filter selected from the group consisting of a cyclone, a baghouse filter and a HEPA filter.

7. The chemical system of claim 5, wherein said separator comprises a gas filter selected from the group consisting of a pressure or temperature swing absorption system, a distillation system and a membrane separator.

8. The chemical system of claim 1, wherein said processing system further comprises at least one device selected from among:
1) a compressor for increasing the pressure of said low temperature fluid flow to between 1 and 1,000 bar absolute pressure;
2) a measurement device for measuring a flow rate of said gas flow of said processed hydrogen at said low gas temperature; and
3) a gas analyzer for measuring a chemical composition and a purity of said processed hydrogen gas at said low gas temperature.

9. The chemical system of claim 1, wherein said heat exchanger is configured to decrease the temperature of said high temperature fluid flow of said pyrolysis products to below 500° C. or below 300° C.

10. The chemical system of claim 1, wherein said heat exchanger further exchanges heat between said high temperature fluid flow of said pyrolysis products and said hydrocarbon feedstock.

11. The chemical system of claim 1, wherein said heat exchanger is configured to increase the temperature of said gas flow of said processed hydrogen gas such that said high gas temperature is above 300° C. or above 700° C.

12. The chemical system of claim 1, wherein said heat exchanger is a counter-flow heat exchanger.

13. The chemical system of claim 1, wherein said heat exchanger exchanges heat between at least one of said high temperature fluid flow of said pyrolysis products and said processed hydrogen gas at said low gas temperature and at least one heat exchange fluid selected from the group consisting of air, steam, molten metals, molten salts and water.

14. A chemical process for producing system for producing a processed hydrogen gas at a high gas temperature, said chemical process comprising:
a) pyrolyzing a hydrocarbon feedstock to produce a high temperature fluid flow of pyrolysis products containing primarily hydrogen and a solid carbon product;
b) passing said high temperature fluid flow of said pyrolysis products through a heat exchanger to deliver a low temperature fluid flow of said pyrolysis products;
c) processing said low temperature fluid flow of said pyrolysis products to obtain said processed hydrogen gas at a low gas temperature, whereby said processing comprises at least one of a step of separation of said solid carbon product and a step of compression; and
d) returning said processed hydrogen gas at said low gas temperature to said heat exchanger such that said heat exchanger exchanges heat between said high temperature fluid flow of said pyrolysis products and said processed hydrogen gas at said low gas temperature to cool said high temperature fluid flow and to heat said processed hydrogen gas at said low gas temperature to produce said processed hydrogen gas at said high temperature.

15. The chemical process of claim 14, wherein said hydrocarbon feedstock substantially comprises methane or natural gas and said solid carbon product comprises solid carbon.

16. The chemical process of claim 14, wherein said pyrolyzing step is performed at a temperature between 500° C. and 2,000° C.

17. The chemical process of claim 14, wherein a fraction of said solid carbon product is fluidized out of said pyrolysis reactor by said high temperature fluid flow of said pyrolysis products.

18. The chemical process of claim 14, wherein said step of separation separates out over 60% of said solid carbon product from said low temperature fluid flow of said pyrolysis products to yield said processed hydrogen gas containing over 70% hydrogen.

19. The chemical process of claim 18, wherein said step of separation uses a solid filter selected from the group consisting of a cyclone, a baghouse filter and a HEPA filter.

20. The chemical process of claim 18, wherein said step of separation uses a gas filter selected from the group consisting of a pressure or temperature swing absorption system, a distillation system and a membrane separator.

21. The chemical process of claim 14, wherein said step of compression uses a compressor for increasing the pressure of said low temperature fluid flow to between 1 and 1,000 bar absolute pressure.

22. The chemical process of claim 14, wherein said step of passing through said heat exchanger is configured to decrease the temperature of said high temperature fluid flow of said pyrolysis products to below 500° C. or below 300° C.

23. The chemical process of claim 14, wherein said step of passing through said heat exchanger further includes passing said hydrocarbon feedstock through said heat exchanger to exchange heat between said high temperature fluid flow of said pyrolysis products and said hydrocarbon feedstock.

24. The chemical process of claim 14, wherein said step of passing through said heat exchanger is configured to increase the temperature of said gas flow of said processed hydrogen gas such that said high gas temperature is above 300° C. or above 700° C.

25. The chemical process of claim 14, wherein in said passing step said heat exchanger exchanges heat between at least one of said high temperature fluid flow of said pyrolysis products and said processed hydrogen gas at said low gas temperature and at least one heat exchange fluid selected from the group consisting of air, steam, molten metals, molten salts and water.
